(19) United States
(12) Patent Application Publication
(10) Pub. No.: US 2016/0358153 A1
(43) Pub. Date: Dec. 8, 2016

(54) SYSTEM AND METHOD FOR MEASURING ELECTRICAL ENERGY WITH FUNCTIONS OF PRE-PAY AND DATA COLLECTION BY MEANS OF AN OPTICAL DEVICE

(71) Applicant: INSTITUTO DE INVESTIGACIONES ELÉCTRICAS, Cuernavaca, Morelos (MX)

(72) Inventors: David PASCACIO MALDONADO, Cuernavaca, Morelos (MX); Roberto CASTAN LUNA, Cuernavaca, Morelos (MX); Rito MIJAREZ CASTRO, Cuernavaca, Morelos (MX); Agustin Javier ANTUNEZ ESTRADA, Cuernavaca, Morelos (MX); Joaquin Hector RODRIGUEZ RODRIGUEZ, Cuernavaca, Morelos (MX); Jose Martin GOMEZ LOPEZ, Cuernavaca, Morelos (MX)

(21) Appl. No.: 14/442,643

(22) PCT Filed: Sep. 25, 2013
(86) PCT No.: PCT/MX2013/000113

§ 371 Date: Aug. 24, 2016

(30) Foreign Application Priority Data
Nov. 14, 2012 (MX) MX/A/2012/013688

(51) Int. Cl. G06Q 20/28; G01R 22/10; G07F 15/00; G07F 15/02; G06Q 50/06; G06Q 20/38

(52) U.S. Cl. CPC G06Q 20/28; G06Q 50/06; G06Q 20/3829; G07F 15/003; G07F 15/02; G01R 22/10

(57) ABSTRACT

The invention relates to a system and a method for measuring electrical energy with functions of pre-pay and data collection by means of an optical recharging device, comprising an electronic pre-pay meter with a supply connection/deconnection module, an optical recharging device, an energy sale-purchase module, a server containing measurement data collection and recharging management software, and a remote communication network.

### FIELD AND BACKGROUND OF THE INVENTION

The growing electric power demand has prompted the burning of a higher amount of coal and gas which has generated an increase in carbon dioxide emissions, despite currently there is a great amount of pressure by international organizations to reduce such emissions. The efficient management of electric power plays an important role in the reduction of consumption, thus helping to bridge the gap between supply and demand, and the reduction of the carbon dioxide emissions. In some countries the law demands a timely information exchange with the consumers to ease the management of their consumption through breakthrough measuring and communications technologies.

The foregoing requires the use of power measuring schemas that are versatile, accurate, trustworthy and intelligent regarding traditional systems, such that, currently, it is necessary that besides relying on meters that register the user's consumption for invoicing, systems that allow the implementation of different types of rates be used; that consider the implementations of prepayment systems; that allow implantation of an efficient demand control and especially allow to include information services to the customer to control the power consumption and make users more conscious thereof. In this regard, electric power measuring performed by intelligent devices and their communications systems, allow carrying out different management schemes for the supply of electric power, which includes prepayment systems.

The electronic prepayment meter, is an intelligent meter that operates with the anticipated payment for the electric power consumption to the utility company, where the meter will be fed with information of such payment by different methods. A credit balance in the meter accredited by the anticipated payment of electric power consumption allows the flow of electric power into the user's property.

There are different prepayment methods, systems and devices conforming the state of the practice, for example:

Patent number WO03/101143 reports a remote measuring system orientated to prepayment schemes of the utility companies, although it can be applied for water or gas services. The system uses the split meter concept (“split meter”), where the meter and the control components of the meter are located away from the user, at pole level, so that the connection and disconnection switches are not accessible to the user avoiding possible interventions and minimizing the risk of improper meter handling. The split meter also has a user interface located in the property of the end user. The user interface comprises a keyboard and a display unit (“display”), which allows the user performing prepayments and monitor the available credit balance. The user interface and the meter are interconnected through a wired communication channel. Several meters can be housed in only one cabinet, into which a network controller, with communications capability, is also integrated. The network controller contains a group of servo-controlled switches. One switch contact is connected to the meter and the other contact is connected to the user interface. Additionally, groups of network controllers are connected to a master station through a communications channel, which can be GSM, WAM radio, PLC, or a combination of these remote communication technologies. The network controller performs the periodical monitoring of each connected meter and uploads predefined data to the meters. Additionally, the network controller has storage capability for measuring data coming from the several meters. The master station, on its own, performs the automatic reading of the meters, periodically inquiring each network controller and storing their measuring data. Unlike the system and prepayment method discussed herein, this patent does not include an electric power prepayment system comprising an electronic prepayment meter with an electric power connection/disconnection device and capability of communication with a bidirectional optical communication device. Neither does it include the electric power credit balance recharge method using a bidirectional optical device, as well as the implementation of the electronic circuitry comprising the bidirectional optical communication device.

U.S. Pat. No. 4,240,030 describes an intelligent meter for electric power consumption, equipped with a special circuit and components that work with a magnetic card inserted to regulate the electric power supply in conjunction with additional screens showing kilowatt-hours, and the corresponding currency value for the current payment period. Unlike the system and prepayment method discussed herein, this patent does not include an electric power prepayment system comprising an electronic prepayment meter with an electric power connection/disconnection device and capability of communication with a bidirectional optical communication device. Neither does it include the electric power credit balance recharge method using a bidirectional optical device, as well as the implementation of the electronic circuitry comprising the bidirectional optical communication device.

U.S. Pat. No. 7,840,493 presents a prepayment system for electric power meters using a contactless intelligent card and an automatic connection and disconnection device and an electric power prepayment method using the following elements: i) a prepayment contactless intelligent card containing a microcontroller and a memory that stores a credit balance value for an amount of prepaid electric power; ii) an electric power electronic meter comprising a contactless intelligent card reader-writer located inside the electric power meter and a memory; and iii) a network including a point of sale terminal having a couple of security modules, a server connected through a communication interface to a data collection system that keeps information on the customer's invoices and about the information stored in a supplier's database. Unlike the system and prepayment method discussed herein, this patent does not include an electric power prepayment system comprising an electronic prepayment meter with an electric power connection/disconnection device and capability of communication with a bidirectional optical communication device. Neither does it include the electric power credit balance recharge method using a bidirectional optical device, as well as the implementation of the electronic circuitry comprising the bidirectional optical communication device.

Patent Application US 20070083479 presents a method, apparatus, and storage device of a prepayment measuring system comprising an electric power meter, an electric power prepayment device, a customer interface unit based on a keyboard for capturing the prepaid credit and an income management system. The electric power meter is interconnected with the electric power prepayment device, which contains a switch to control connection/disconnection of the electric power service of a customer, which also contains the management and control of the credit of use of electric power prepaid by the customer, and the data related to the use of the electric power. Unlike the system and prepayment method discussed herein, this patent does not include an electric power prepayment system comprising an electronic prepayment meter with an electric power connection/disconnection device and capability of communication with a bidirectional optical communication device. Neither does it include the electric power credit balance recharge method using a bidirectional optical device, as well as the implementation of the electronic circuitry comprising the bidirectional optical communication device.

### SUMMARY OF THE INVENTION

The object of the invention herein is an electric power prepayment system and method that uses an intelligent electronic prepayment electric power meter with an automatic connection/disconnection electric power supply device and a bidirectional optical communication device.

It is also object of this invention the device with bidirectional optical communication for electric power credit balance recharge.

Another object of this invention is the interaction method between the bidirectional optical communication device and the intelligent electric power prepayment meter.

### BRIEF DESCRIPTION OF THE DRAWINGS

FIG. 1 is a view of the general functional scheme of the electric power measuring system with functions of prepayment and data collection by means of an optical device of this invention. Where (1) is an electronic prepayment meter with a supply connection/disconnection module, (2) is a recharge optical device, (4) is a buy-sell electric power module, (5) is a remote communication network, and (6) is a server hosting a recharge management and measuring data collection software.

FIG. 2 is an isometric view of the inner structure of the electronic meter that integrates the electric power measuring system with functions of prepayment and data collection by means of optical device in this invention.

FIG. 3 is a view of the block diagram of the inner structure of the electronic meter that integrates the electric power measuring systems with functions of prepayment and data collection by means of optical device in this invention. Where (12) is a control, measurement and processing block, (19) is a numeric and alphanumeric information display block, (17) is an electric power supply connection/disconnection block, (16) is a power driver for triggering the connection/disconnection block, (15) is a power source block with a voltage duplicator and electric power condenser for triggering the connection/disconnection block, (20) is a communication block via optical port, (13) is a memory block, (21) is an acceleration detection block, and (14) is a current sensor.

FIG. 4 is an isometric view of the electronic device with bidirectional optical communication for electric power recharge and data transfer that is part of the electric power measuring system with functions of prepayment and data collection by means of optical device in this invention.

FIG. 5 is a view of the block diagram of the structure of the electronic device with bidirectional optical communication for electric power recharge and data transfer that is part of the measuring system with functions of prepayment and data collection by means of optical device in this invention. Where (28) is a control and processing block, (30) is an information storage block, (29) is a communication block via optical port, (31) is a module activation block, and (32) is a power supply block.

FIG. 6 is a view of the block diagram of the structure of the module activation block that is part of the recharge optical device of the electric power measuring system with functions of prepayment and data collection by means of optical device in this invention. Where (33) is a magnetic switch and (34) is a pressure switch.

FIG. 7 is a view of the block diagram of the structure of the recharge module of the point of sale that is part of the electric power measuring system with functions of prepayment and data collection by means of optical device in this invention. Where (38) is a personal computer, which contains a software for electric power selling, and (39) is a point of sale recharge module.

FIG. 8 is a view of the block diagram of the structure of the electric power buy-sell module that is part of the electric power measuring system with functions of prepayment and data collection by means of optical device in this invention. Where (35) is a universal serial bus USB port block, (36) is an optical port, and (37) is a magnetic activation element.

FIG. 9 is a view of the flowchart of the electric power credit balance recharge method that is part of the electric power measuring system with functions of prepayment and data collection by means of optical device in this invention.

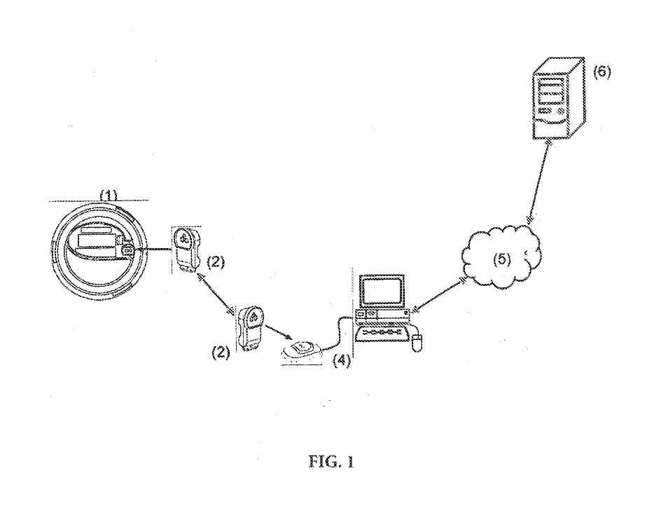

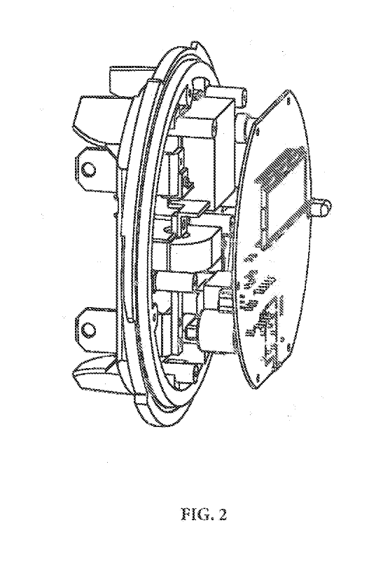

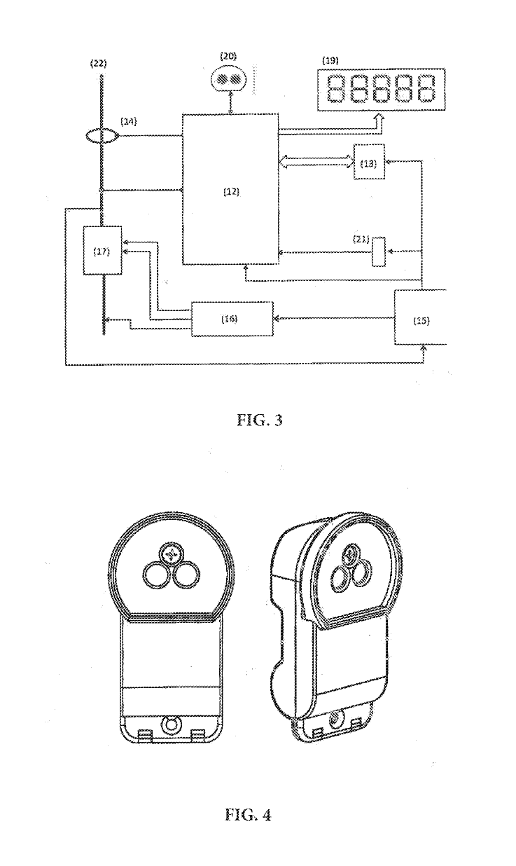

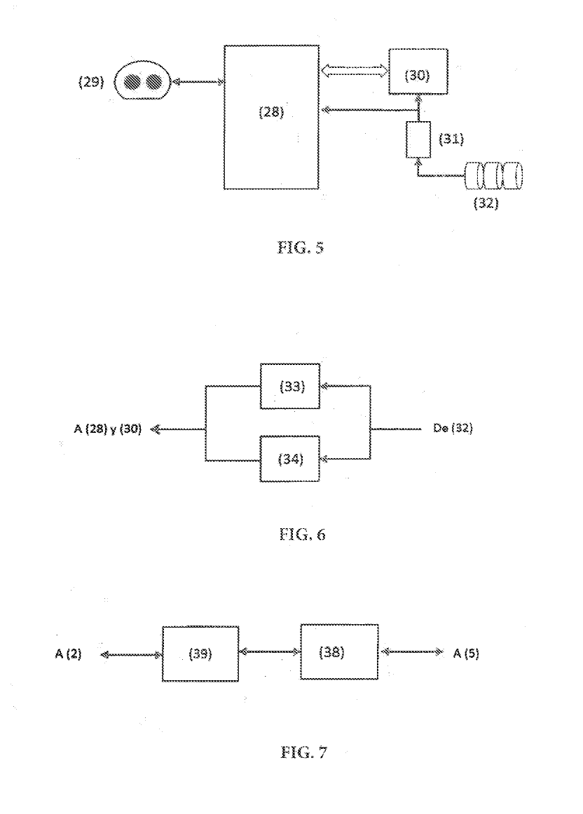

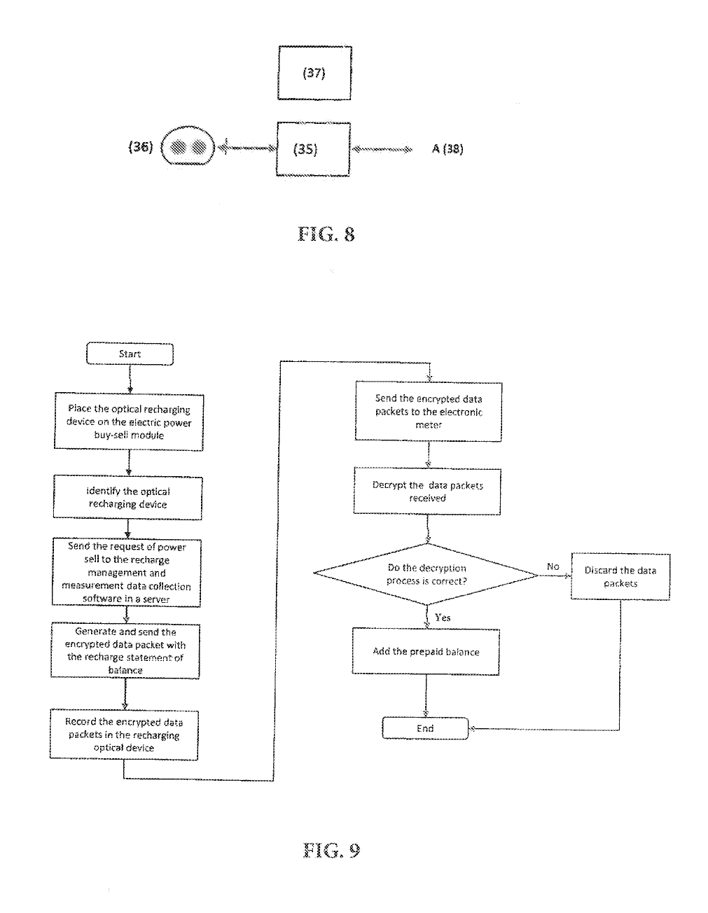

### DETAILED DESCRIPTION OF THE INVENTION

As object of the present invention and as a reference to the drawings, an electric power measuring system with functions of prepayment and data collection by means of an optical device is presented, comprising an electronic prepayment meter with a supply connection/disconnection module (1), an optical recharging device (2), an electric power buy-sell module (4), a recharge management and measurement data collection software in a server (6), and a remote communication network (5).

The electronic prepayment meter with supply connection/disconnection module (1) which consists of the following functional blocks: a control, measurement and processing block (12), a numeric and alphanumeric information display block (19), an electric power supply connection/disconnection block (17), a power driver for triggering the connection/disconnection block (16), a power source block with voltage duplicator and power condenser for triggering the connection/disconnection block (15), an optical communication port block (20), a memory block (13), an acceleration detection block (21), an encryption/decryption of data packets block running on the measurement and processing block (12), and a current sensor (14).

The optical recharging device (2) comprises the following functional blocks: a control and processing block (28), an information storage block (30), an optical communication port block (29), a module activation block (31), a power supply block (32), and a unique encryption key contained in the control and processing block (28).

The activation block module (31) consists of a magnetic switch (33) and a pressure switch (34), both of which maintain the power supply block (32) disconnected from the rest of the circuit to save power.

The electric power buy-sale module (4), consists of the following main elements: a personal computer (38), which contains an electric power sale software and a point of sale recharge module (39), which consists of the following main elements: a universal serial bus USB port block (35), an optical port block (36), and a magnetic activation element (37).

The method for automatic disconnection of the electric power supply is performed by the control, measurement and processing block (12) of the electric power prepayment electronic meter (1) performs the measurement of electric power consumption through constant reading of a current sensor (14) and the voltage present in the connections (22); performs the corresponding mathematical operations to obtain the consumption value of electric power; stores the obtained values in the memory block (13) on a regular basis and uses these stored data to be continuously displayed on the numeric and alphanumeric information display block (19); performs the discount of electric power balance automatically subtracting the credit according to the electric power consumed; performs automatic disconnection of the supply of electric power to the user when the prepaid credit balance of electric power reaches a programmed threshold, which can be a minimum amount of credit balance required to continue receiving service or an amount of maximum debt balance allowed to the user after depleting the prepaid credit balance. It awaits acknowledgment messages, measurement information reading,

balance recharging, operation parameters reading, connection/disconnection of the electric power supply, settings and operation parameters reprogramming and remote firmware updating. These messages come from the electric power recharging optical device (2) and are received through its optical port communication block (20).

The electric power credit balance recharge method through the recharging optical device (2) is performed per the following steps: 1) The user transports the recharging optical device (2) to a place having an electric power buy-sell module (4); 2) the recharging optical device is located (2) over the point of sale recharging module (39), which, through its magnetic activation element (37), triggers the magnetic switch (33) to energize the recharging optical device (2); 4) the recharging optical device (2) is identified and the encrypted data packets in it are extracted, which come from the electric power prepayment electronic meter (1) associated, through the electric power selling software residing in the personal computer (38); 5) the electric power sale request is sent, through the remote communication network (5), to the server (6) where the management software resides, with the amount of electric power requested by the user, as well as the identification information of the recharging optical device (2) and its associated electronic meter (1), as well as the encrypted data packets extracted from the recharging optical device (2); 6) the management software in the server (6) generates and sends an encrypted data packet using a unique encryption code to the associated electronic prepayment meter (1), such packet contains the recharging direction of the credit balance according to the requested amount. Additionally, the management software residing in the server (6) generates and sends various encrypted messages for recognition, measuring information reading, operation parameters reading, electric power supply connection/disconnection, settings and operation parameters reprogramming and remote firmware updating; 7) the electric power buy-sell module (4) receives the encrypted data packets and records them in the information storage block (30) of the recharging optical device (2) through the point of sale recharge module (39); 8) the user can perform the credit balance recharge to his electric power meter (1) placing the recharging optical device (2) associated on the communication block by optical port (20) of the electronic meter (1) and pressing the pressure switch (34) of the recharging optical device (2); 9) the recharging optical device (2) sends the encrypted data packets to the electric power prepayment electronic meter (1) through a defined protocol; 10) the electric power prepayment electronic meter (1) decrypts the data packets received through the unique encryption key. If the result of the decryption process is correct, it adds the prepaid credit balance received from the recharging optical device to the current prepaid credit balance in the meter (1), additionally it executes the directions for measuring information reading, operation parameters reading, electric power supply connection/disconnection, settings and operation parameters reprogramming and remote firmware updating; 11) the recharging optical device (2) requests the information related to the electric power consumption measuring and events detection from the electric power electronic meter (1) encrypts and sends data packets containing the information requested by the recharging optical device (2) using its unique encryption key.

Having described the above, it is considered a novelty of the invention and, therefore, claimed as property the contained in the following claims or clauses.

1. An electric power measuring system with functions of prepayment and data collection by means of a recharging optical device, comprising a prepayment electronic meter with a supply connection/disconnection module, a recharging optical device, an electric power buy-sell module, a server containing a recharging management and measuring data collection software and a remote communication network.

2. An electric power measuring system with functions of prepayment and data collection by means of a recharging optical device, in accordance to claim 1, where the recharging optical device is a self-contained intelligent electronic module and with bidirectional communication to transfer information between electric power electronic meters and the utility company, which it adheres to the electronic meter without a connection cable to the meter's optical port.

3. An electric power measuring system with functions of prepayment and data collection by means of a recharging optical device, in accordance to claims 1 and 2, where the recharging optical device consists of the following functional blocks: a control and digital processing block, a nonvolatile digital information storage block, an optical port communication block, a module activation block, a power supply block, and a unique encryption key contained in the control and processing block.

4. An electric power measuring system with functions of prepayment and data collection by means of a recharging optical device, in accordance to claims 1, 2 and 3, where the recharging optical device is activated by a module activation block that comprises a magnetic switch and a pressure switch, both of which keep the power supply block disconnected from the rest of the circuit to save the energy from the batteries.

5. An electric power measuring system with functions of prepayment and data collection by means of a recharging optical device, in accordance to claim 1, where the electric power buy-sell module consists of a personal computer and a point of sale recharging module that comprises a universal serial bus USB port block, an optical port block, and a magnetic element activating the recharging device.

6. An electric power measuring system with functions of prepayment and data collection by means of a recharging optical device, in accordance to claim 1, where the remote updating of the firmware of the electric power prepayment electronic meter is carried out through an electric power credit balance recharging optical device.

7. An electric power recharging optical device for prepayment meters characterized by the following functional blocks: a control and processing block, an information storage block, a communication through an optical port block, a module activation block, a power supply block, and a unique encryption key contained in the control and processing block. Where the module activation block consists of a magnetic switch and a pressure switch, both of which keep the power supply block disconnected from the rest of the circuit to save energy.

8. An electric power measuring method with functions of prepayment, data collection and remote firmware updating through an optical device, that comprises the following steps:
a) Place the recharging optical device over the point of sale recharging module;
b) identify the recharging optical device using an electric power sale software in the personal computer through a defined protocol;
c) send, through a remote commtnication network, the electric power sell request to the server where the management software resides with the electric power amount requested by the user, as well as the identification information of the recharging optical device and its associated electronic meter;
d) generate end send from the management software residing in the server an encrypted data packet using a unique encryption key for the associated prepayment electronic meter, which contains the credit balance recharge direction according to the requested amount;
e) receive and record, in the recharging optical device, the encrypted data packets through the point of sale recharging module;
f) send the encrypted data packets to the electric power prepayment electronic meter through a defined protocol upon placing the associated recharging optical device in the communication through optical port block of the electronic meter and pressing the pressure switch from the recharging optical device;
g) decrypting the received data packets through a unique encryption key and add the received prepaid credit balance if the result of the decryption process is correct.
